(19) United States
(12) Patent Application Publication
(10) Pub. No.: US 2026/0027980 A1
(43) Pub. Date: Jan. 29, 2026

(54) TRANSMISSION STRUCTURE OF COUNTERWEIGHT-FREE CAR CAMERA CRANE

(71) Applicant: SHENZHEN TILTA TECHNOLOGY CO., LTD., Shenzhen, Guangdong (CN)

(72) Inventors: Yaolong LUO, Shenzhen (CN); Zheng FU, Shenzhen (CN); Yiling WANG, Shenzhen (CN)

(21) Appl. No.: 18/992,058

(22) PCT Filed: Jun. 9, 2022
(86) PCT No.: PCT/CN2022/097935

§ 371 Date: Mar. 10, 2025

(30) Foreign Application Priority Data
May 19, 2022 (CN) 202221236313.3

(51) Int. Cl. B60R 11/04; F16M 11/10

(52) U.S. Cl. CPC B60R 11/04; F16M 11/10

(57) ABSTRACT

A transmission structure for a counterweight-free vehicle-mounted jib arm, including a servo cylinder and a stabilizer link component, wherein the servo cylinder is mounted on a main structural framework and connected to the stabilizer link component to push the stabilizer link component. The stabilizer link component is further connected to an arm docking component, and the servo cylinder acts on the arm docking component via the stabilizer link component. Additionally, gas springs are included in the jib arm support structure, arranged on two sides of the servo cylinder and connected to the stabilizer link component. The servo cylinder drives the stabilizer link component to act on the arm docking component, and changes its direction of movement, altering the force from tension to thrust, thereby modifying the force-bearing structure of the servo cylinder, eliminating the damage. This design effectively protects the servo cylinder's structure, enhances equipment safety, and extends its service life.

### CROSS-REFERENCE TO RELATED APPLICATIONS

The present application for patent claims priority to and the benefit of pending PCT Application No. PCT/CN2022/097935, filed Jun. 9, 2022, and hereby expressly incorporated by reference herein as if fully set forth below in its entirety and for all applicable purposes.

### TECHNICAL FIELD

The present disclosure pertains to the realm of photographic equipment, specifically to a transmission structure for a counterweight-free vehicle-mounted jib arm.

### INTRODUCTION

Vehicle-mounted jib arms constitute substantial photographic equipment utilized in the creation of large-scale film and television projects, such as TV dramas, movies, and advertisements. They are primarily employed to capture dynamic scenes, including car chases, people running, and horse riding, from various angles during filming, allowing for framing during rapid movements.

Currently, the majority of existing vehicle-mounted film and television jib arm technologies employ large-scale jib arm equipment that cannot be disassembled swiftly. A counterweight bar, exceeding one meter in length, is positioned behind the pitching axis boom of the jib arm to balance the front and rear centers of gravity. During filming, due to constraints in the filming environment width, when the jib arm rotates laterally, the rear counterweight bar frequently collides with obstacles adjacent to the vehicle body.

Therefore, Patent Application No. 202120982923.7 reveals an ultra-low-height, counterweight-free vehicle-mounted jib arm filming system, encompassing a base, a rotating part, a jib arm, and a shock absorption part. The rotating part comprises a housing, a framework, a clump weight, a servo cylinder, a motor, a pinion gear, and a large gear positioned above the base. The servo cylinder connects to a quick docking structure via a clamping member, and the quick docking structure attaches to the jib arm. The opposite end of the jib arm connects to a camera mounting plate of a gimbal through the shock absorption part, which incorporates shock absorption springs and a universal joint structure made up of pitch damping rods and yaw damping rods.

In this patent application, gas springs aid the servo cylinder, minimizing the force exerted on it. This elimination of the need to balance the boom's center of gravity negates the requirement for counterweights. This facilitates ease of assembling and transportation for users and reduces vulnerability to obstacles in the surrounding filming environment. However, the primary function of the servo cylinder is to serve as an assembly of several structures while supporting the jib arm and controlling its movement. Consequently, the servo cylinder undergoes numerous tensile motions. Subject to long-term tensile force, this structure may lead to damage to bolts and other connecting components, resulting in structural failure and compromising the equipment's quality and lifespan. Furthermore, the filming system is mounted and operated on a vehicle, and vehicle movement can induce vibrations to the equipment, causing uneven force distribution on the servo cylinder, which can readily cause structural harm to the servo cylinder and impair its lifespan.

### BRIEF SUMMARY

To address the aforementioned issues, the primary objective of the present disclosure is to provide a transmission structure for a counterweight-free vehicle-mounted jib arm. This structure, through improvements to the servo cylinder, transforms its previous tensile motion into a push-pull motion, effectively protecting the servo cylinder's structure, enhancing equipment safety, and extending its service life.

Another objective of the present disclosure is to provide a transmission structure for a counterweight-free vehicle-mounted jib arm that incorporates a stabilizer link to generate thrust from the servo cylinder and utilizes gas springs to provide stable thrust. The stabilizer link balances the weight load at the front end of the jib arm, thereby achieving a counterbalancing effect.

To achieve the above objectives, the technical solution of the present disclosure is as follows:

A transmission structure for a counterweight-free vehicle-mounted jib arm, including a servo cylinder and a stabilizer link component, wherein the servo cylinder is mounted on a main structural framework and connected to the stabilizer link component to push the stabilizer link component. The stabilizer link component is further connected to an arm docking component, and the servo cylinder acts on the arm docking component via the stabilizer link component. Additionally, gas springs are included in the jib arm support structure, arranged on two sides of the servo cylinder and connected to the stabilizer link component. The gas spring provides thrust to the stabilizer link component, balancing the load weight at the front end of the jib arm. The servo cylinder drives the stabilizer link component to act on the arm docking component, and changes its direction of movement, altering the force from tension to thrust, thereby modifying the force-bearing structure of the servo cylinder. This design effectively protects the servo cylinder's structure, enhances equipment safety, and extends its service life.

Furthermore, the stabilizer link component includes a front swing arm, a rear swing arm, and a stabilizer link. The front swing arm is mounted on the arm docking component. A first end of the stabilizer link is hinged to the front swing arm, and a second end is hinged to the rear swing arm.

Moreover, the front swing arm and the rear swing arm are arranged in parallel. The stabilizer link component includes two stabilizer links, arranged in parallel, and the two stabilizer links, along with the front swing arm and the rear swing arm, form a parallelogram structure, transmitting the force of the servo cylinder to the jib arm stably.

The front swing arm has two fulcrums for the stabilizer link, and the rear swing arm has a fulcrum for the pull rod of the stabilizer link. The four fulcrums of the front and rear swing arms form a parallelogram structure, ensuring consistent motion angles for both arms. This enables the thrust of the servo cylinder to act evenly on the front swing arm. The servo cylinder pushes the rear swing arm to move, and drives the front swing arm to move through the stabilizer link component. This structure changes the force direction of the cylinder. When the vehicle-mounted jib arm travels on a bumpy road, the force of the servo cylinder is an inward thrust, which better withstands the impact force generated by inertia, improving equipment safety.

Furthermore, one end of the gas spring is installed on the main structural framework or on the base of the servo cylinder and is connected to the rear swing arm. In this way, the gas spring pushes the rear swing arm and pulls the jib arm through the stabilizer link component, balancing the weight load at the front end of the jib arm. The gas spring balances out the force of the front jib arm, thereby reducing the force exerted by the servo cylinder. Considering that the output direction of a normal gas spring is mostly thrust, and the technology is mature, using its thrust in reverse can protect the gas spring structure and enhance its safety and lifespan.

Even further, two gas springs are provided, arranged on both sides of the servo cylinder, to exert a balancing force on the stabilizer link component. The two gas springs generate sufficient thrust to balance the weight load at the front end of the jib arm.

### Beneficial Effects of the Present Disclosure

The present disclosure is featured by connecting the servo cylinder to the stabilizer link component. The servo cylinder drives the stabilizer link component to act on the arm docking component, and changes its direction of movement, altering the force from tension to thrust, thereby modifying the force-bearing structure of the servo cylinder, eliminating the damage. This design effectively protects the servo cylinder's structure, enhances equipment safety, and extends its service life.

### BRIEF DESCRIPTION OF THE DRAWINGS

FIG. 1 is a schematic illustrating a transmission structure for a counterweight-free vehicle-mounted jib arm according to some aspects of the present disclosure.

FIG. 2 is a schematic illustrating an action of the transmission structure for a counterweight-free vehicle-mounted jib arm when the jib arm is ascending.

FIG. 3 is a schematic illustrating a side view of an action of the transmission structure for a counterweight-free vehicle-mounted jib arm when the jib arm is ascending.

FIG. 4 is a schematic illustrating an action of the transmission structure for a counterweight-free vehicle-mounted jib arm when the jib arm is descending.

FIG. 5 is a side view of the action of the present disclosure when the jib arm is descending.

In the drawings: 1, jib arm; 2, arm docking component; 3, servo cylinder; 4, stabilizer link component; 5, gas spring; 6, main structural framework; 7, wire rope brace; 8, push rod support arm; 9, mounting rod; 21, front swing arm bushing; 31, servo cylinder base bearing; 32, servo cylinder push rod bearing; 41, stabilizer link; 42, front swing arm; 43, rear swing arm.

### DETAILED DESCRIPTION

To clarify the objectives, technical solutions, and advantages of this disclosure, further detailed descriptions are provided below in conjunction with the accompanying drawings and embodiments. It should be noted that the specific embodiments presented herein are solely for the purpose of illustrating this disclosure and are not intended to restrict its scope.

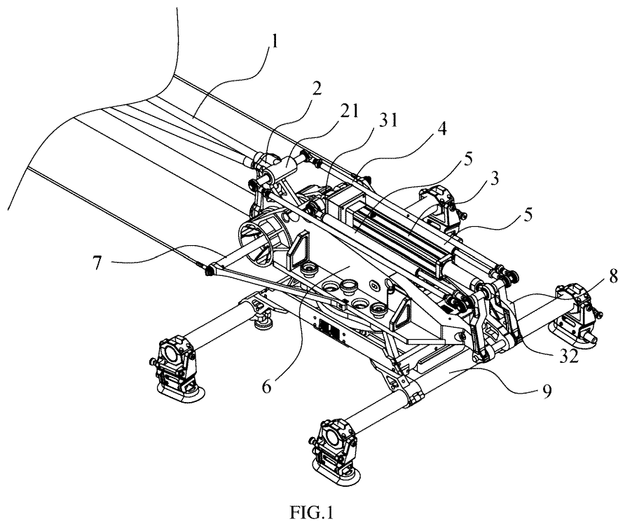

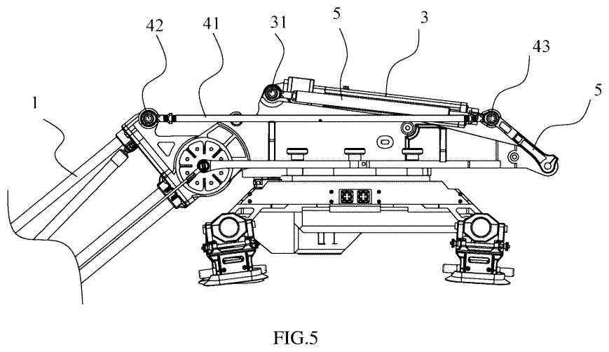

As depicted in FIGS. 1 to 5, the transmission structure for a counterweight-free vehicle-mounted jib arm, realized by the present disclosure, includes a servo electric cylinder 3 (servo cylinder) and a stabilizer link component 4. The servo electric cylinder 3 is mounted on the main structural framework 6 and is interconnected with the stabilizer link component 4, pushing the stabilizer link component 4. The stabilizer link component 4 is connected to the arm docking component 2, which subsequently connects to the jib arm 1. The servo electric cylinder 3 exerts force on the arm docking component 2 via the stabilizer link component 4, causing the arm docking component 2 to pull the jib arm 1 into motion. The servo electric cylinder 3 faces away from the jib arm 1, generating thrust. The reaction force of the jib arm 1 exerts pressure on the servo electric cylinder 3. This alteration in the force-bearing structure of the servo electric cylinder 3 prevents destructive tension on the structure, effectively safeguarding the servo cylinder and enhancing equipment safety.

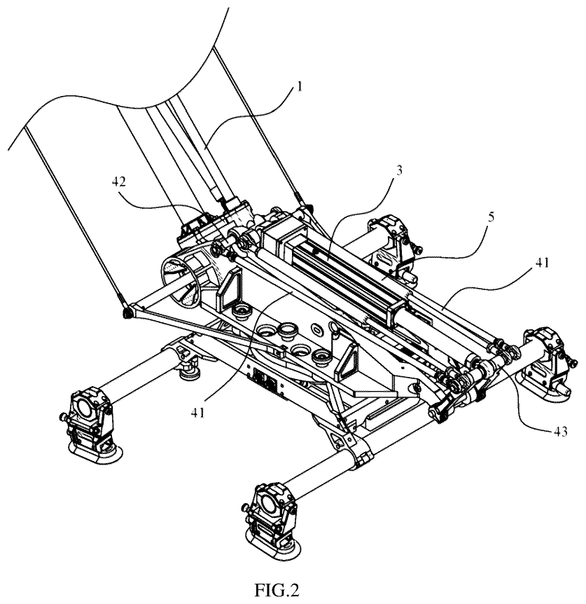

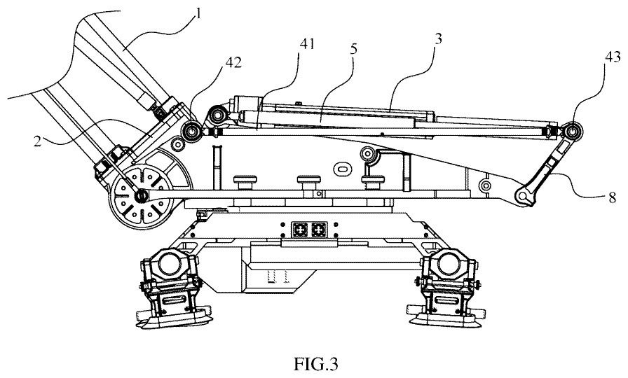

Considering FIGS. 2 and 3, specifically, the stabilizer link component 4 includes a front swing arm 42, a rear swing arm 43, and a stabilizer link 41. The front swing arm 42 connects to the arm docking component 2 through a front swing arm bushing 21 on the existing arm docking component 2. The rear swing arm 43 is hinged to the push rod support arm 8, which is movably connected to the mounting rod 9. One end of the stabilizer link 41 is hinged to the front swing arm 42, while the other end is hinged to the rear swing arm 43.

The front swing arm 42 and the rear swing arm 43 are arranged in parallel. Additionally, there are two stabilizer links 41, each hinged to the respective ends of the front swing arm 42 and the rear swing arm 43, and both stabilizer links 41 are arranged in parallel. In this configuration, the two stabilizer links 41, along with the front swing arm 42 and the rear swing arm 43, form a parallelogram.

The front swing arm 42 has two fulcrums for the stabilizer link 41, and the rear swing arm 43 has a fulcrum for the pull rod of the stabilizer link 41. The four fulcrums of the front and rear swing arms form a parallelogram structure, ensuring consistent motion angles for both arms. This enables the thrust of the servo electric cylinder 3 to act evenly on the front swing arm 43. The servo electric cylinder 3 pushes the rear swing arm 43 to move, and drives the front swing arm 42 to move through the stabilizer link component 41. Subsequently, the front swing arm 42 exerts force upon the arm docking component 2, which in turn drives the jib arm 1 to perform an upgraded motion. This structure changes the force direction of the cylinder. When the vehicle-mounted jib arm travels on a bumpy road, the force of the servo cylinder is an inward thrust, which better withstands the impact force generated by inertia, improving equipment safety.

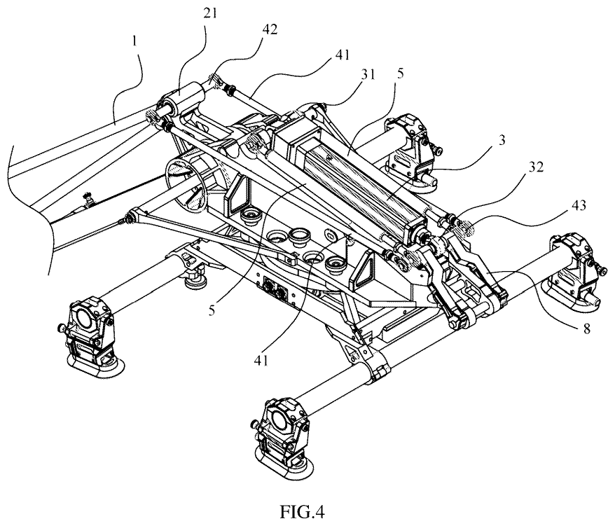

The present disclosure further incorporates gas springs 5 (gas springs). As shown in FIGS. 2 and 4, the gas springs 5 are positioned on two sides of the servo electric cylinder 3 and are connected to the stabilizer link component 4. The gas springs 5 provide thrust to the stabilizer link component 4, balancing the load weight at the front end of the jib arm.

Specifically, the gas springs 5 are hinged to the servo cylinder base bearing 31 and connected to the rear swing arm 43. In this way, the gas springs 5 push the rear swing arm 43 and pull the jib arm through the stabilizer link component, balancing the weight load at the front end of the jib arm. The gas springs balance out the force of the front jib arm, thereby reducing the force exerted by the servo cylinder. Given the relatively modest tensile force of the gas spring, which is constrained by its structural characteristics, prolonged use can readily result in structural deterioration. Using its thrust in reverse can protect the gas spring structure and enhance its safety and lifespan.

In alternative implementations, one end of the gas spring 5 can be mounted on the main structural framework 6 and connected to the rear swing arm 43, which also serves to balance the force on the front arm body while safeguarding the gas spring structure and improving its safety and lifespan.

For better performance, in general, two gas springs 5 are provided, arranged on both sides of the servo electric cylinder 3, to exert a balancing force on the stabilizer link component 41. The two gas springs 5 generate sufficient thrust to balance the weight load at the front end of the jib arm.

As illustrated in FIG. 2, when the jib arm 1 is ascending, the servo electric cylinder 3 generates thrust and propels the rear swing arm 43 via its terminal servo cylinder push rod bearing 32. The rear swing arm 43 then draws the stabilizer link 41 backward, which in turn drives the front swing arm 42 backward. The front swing arm 42 pulls the arm docking component 2, lifting the jib arm 1 upward.

As depicted in FIG. 4, when the jib arm 1 needs to descend and tilts downward, the servo electric cylinder 3 retracts and pulls the rear swing arm 43. The rear swing arm 43 then pulls the stabilizer link 41 forward, pushing the front swing arm 42 forward. Consequently, the stabilizer link 41 propels the front swing arm 42, which then pushes the arm docking component 2, causing the jib arm 1 to droop into the state shown in FIG. 4.

Typically, the actual operating angles required for the jib arm 1 are: 45° upward tilt and 30° downward tilt.

The jib arm 1 and the arm docking component 2 are considered prior art and will not be further elaborated upon here.

The above description outlines a preferred embodiment of the present disclosure and is not intended to limit its scope. Any modifications, equivalent substitutions, and improvements made within the spirit and principles of this utility model should be considered within the scope of its protection.

1. A transmission structure for a counterweight-free vehicle-mounted jib arm, comprising
a servo cylinder and a stabilizer link component, wherein the servo cylinder is mounted on a main structural framework and connected to the stabilizer link component to drive the stabilizer link component;
wherein the stabilizer link component is connected to an arm docking component, and the servo cylinder acts on the arm docking component via the stabilizer link component; and
wherein an gas springs is provided on side of the servo cylinder and connected to the stabilizer link component.

2. The transmission structure for a counterweight-free vehicle-mounted jib arm according to claim 1, wherein the stabilizer link component comprises a front swing arm, a rear swing arm, and a stabilizer link;
wherein the front swing arm is mounted on the arm docking component; and
wherein a first end of the stabilizer link is hinged to the front swing arm, and a second end is hinged to the rear swing arm.

3. The transmission structure for a counterweight-free vehicle-mounted jib arm according to claim 2, wherein the front swing arm and the rear swing arm are arranged in parallel; and
wherein the stabilizer link component comprises two stabilizer links, arranged in parallel, and two stabilizer links, along with the front swing arm and the rear swing arm, form a parallelogram structure.

4. The transmission structure for a counterweight-free vehicle-mounted jib arm according to claim 1, wherein the gas springs is provided on the main structural framework and connected to the rear swing arm.

5. The transmission structure for a counterweight-free vehicle-mounted jib arm according to claim 1, wherein the gas spring is provided on a base of the servo cylinder and connected to the rear swing arm.

6. The transmission structure for a counterweight-free vehicle-mounted jib arm according to claim 4 or claim 5, wherein two gas springs are provided on two sides of the servo cylinder.
